(19) United States
(12) Patent Application Publication
(10) Pub. No.: US 2015/0300037 A1
(43) Pub. Date: Oct. 22, 2015

(54) LIFTING SYSTEM FOR WIND TURBINE TOWERS AND METHOD FOR ERECTING A WIND TURBINE TOWER

(71) Applicant: MARMEN INC., Trois-Riviéres (CA)

(72) Inventor: Patrick PELLERIN, Trois-Rivieres (CA)

(21) Appl. No.: 14/647,744

(22) PCT Filed: Nov. 27, 2013
(86) PCT No.: PCT/CA2013/050908

§ 371 Date: May 27, 2015

Related U.S. Application Data
(60) Provisional application No. 61/730,120, filed on Nov. 27, 2012.

(51) Int. Cl. E04H 12/34; B66C 23/18; E04H 12/00; B66C 23/20; B66C 23/32; F03D 1/00

(52) U.S. Cl. CPC E04H 12/342; B66C 23/32; F03D 1/001; E04H 12/00; B66C 23/207; B66C 23/185

(57) ABSTRACT

A method for erecting a structural tower includes providing a plurality of tower sections and engaging a translatable crane assembly with a lower one of the tower sections. A second one of the tower sections engages with a cable operatively engaged with the translatable crane assembly. The second one of the tower sections is hoisted towards an upper end of the lower one of the tower sections and the second one of the tower sections is secured to the lower one of the tower sections. The method finally includes translating the translatable crane assembly vertically along the secured tower sections towards the upper end thereof. A wind turbine assembly includes a structural tower and a translatable crane assembly.

### CROSS-REFERENCE TO RELATED APPLICATIONS

This application claims priority under 35USC §119(e) of U.S. provisional patent application 61/730,120, filed on Nov. 27, 2012, the specification of which is hereby incorporated by reference.

### TECHNICAL FIELD OF THE INVENTION

The technical field relates to wind turbine tower assemblies and, more particularly, to a lifting system for wind turbine towers and a method for erecting a wind turbine tower.

### BACKGROUND

Towers for wind turbines are typically manufactured in sections or parts which are placed concentrically over each other and bolted together. For erecting and dismantling the towers, heavily over-sized cranes are typically required. The cost of the cranes and the logistics required to erect and dismantle a wind turbine tower increases with the height of the tower. In addition, larger cranes may be difficult to transport in rural areas, rough terrains, mountainous forest lands, etc.

Generally, wind velocity and consistency increase with altitude. Thus, a wind turbine can often produce more electrical energy, and more consistently, when placed at higher altitude. However, the costs of the wind towers increase with the tower height. At some point, the net revenue from the generated electrical energy decreases with increasing tower height due to the construction costs of the tower. Furthermore, the height of the tower can be limited by the height of the crane that can be used to erect the tower.

Thus, the height of the tower may be limited by the construction costs and/or the height of the crane that can be used, thereby limiting the practical altitude of the wind turbines.

### BRIEF SUMMARY OF THE INVENTION

It is therefore an aim of the present invention to address the above mentioned issues.

According to a general aspect, there is provided a wind turbine tower assembly comprising: a structural tower having an elongated tower frame with at least one longitudinally-extending rail member; and a translatable crane assembly having a crane frame slidably engageable with the at least one longitudinally-extending rail member and translatable along the elongated tower frame of the structural tower and a crane mounted to the crane frame.

In an embodiment, the crane is pivotally mounted to the crane frame and selectively configurable in a non-operative configuration and a plurality of operative configurations.

In an embodiment, the crane comprises a boom and a gantry pivotally mounted to the crane frame.

In an embodiment, the structural tower comprises a central section and a plurality of peripheral sections extending radially from the central section and the at least one longitudinally-extending rail member comprises at least two longitudinally-extending rail members, each one of the longitudinally-extending rail members extending between two adjacent ones of the peripheral sections. The crane frame can surround at least one of the peripheral sections of the structural tower.

In an embodiment, the structural tower comprises a plurality of tower sections superposed to one another and secured together, each one of the tower sections comprising a section of the at least one longitudinally-extending rail member, the sections of the at least one longitudinally-extending rail member being aligned to define the at least one longitudinally-extending rail member extending along the structural tower.

In an embodiment, the translatable crane assembly further comprises at least one translation actuator mounted to the crane frame and actuable in consecutive reciprocating movements for translating the crane frame along the structural tower.

In an embodiment, the at least one longitudinally-extending rail member comprises a slotted track with a plurality of apertures and the crane frame comprises at least one pawl engageable with the apertures to allow translation in a single direction. The crane frame can comprise at least one sliding block connected to the at least one translation actuator. The at least one of the pawls can comprise at least two sets of pawls with a first one of the sets of pawls being mounted to the at least one sliding block and a second one of the sets of pawls being mounted to a crane supporting section of the crane frame. The wind turbine tower assembly can further comprise at least one brake assembly connected to the at least two sets of pawls and operative to configure the at least two sets of pawls in an operative configuration allowing translation in a single direction and a non-operative configuration allowing translation in both directions.

In an embodiment, the crane frame comprises bearing assemblies engageable with the at least one longitudinally-extending rail member. In an embodiment, the crane frame comprises at least two bearing assemblies, each one being engageable with a respective one of the longitudinally-extending rail member.

In an embodiment, the crane frame comprises a brake assembly configurable in an engaged configuration to secure the crane frame at a position along the structural tower and a disengaged configuration to allow translation of the crane frame along the structural tower.

According to another general aspect, there is provided a translatable crane assembly for a structural tower having at least one longitudinally-extending rail member. The translatable crane assembly comprises: a crane frame slidably engageable with the at least one longitudinally-extending rail member and a crane mounted to the crane frame.

In an embodiment, the crane is pivotally mounted to the crane frame and selectively configurable in a non-operative configuration and a plurality of operative configurations.

In an embodiment, the crane comprises a boom and a gantry pivotally mounted to the crane frame.

In an embodiment, the crane frame further comprises at least one translation actuator and actuable in consecutive reciprocating movements for translating the crane frame along the structural tower.

In an embodiment, the at least one longitudinally-extending rail member comprises a slotted track with a plurality of apertures and the crane frame comprises at least one pawl engageable with the apertures to allow translation in a single direction. The crane frame can comprise at least one sliding block connected to the at least one translation actuator. The at least one of the pawls can comprise at least two sets of pawls with a first one of the sets of pawls being mounted to the at least one sliding block and a second one of the sets of pawls being mounted to a crane supporting section of the crane frame. The translatable crane assembly can further comprise at least one brake assembly connected to the at least two sets of pawls and operative to configure the at least two sets of pawls in an operative configuration allowing translation in a single direction and a non-operative configuration allowing translation in both directions.

In an embodiment, the crane frame comprises at least one bearing assembly engageable with the at least one longitudinally-extending rail member. In an embodiment, the crane frame comprises at least two bearing assemblies, each one being engageable with a respective one of the longitudinally-extending rail member.

In an embodiment, the crane frame comprises a brake assembly configurable in an engaged configuration to secure the crane frame at a position along the structural tower and a disengaged configuration to allow translation of the crane frame along the structural tower.

According to still another general aspect, there is provided a method for mounting a translatable crane assembly having a crane frame and a crane to an upper end of a structural tower. The method comprises: engaging the crane frame having a crane mounted thereto with the structural tower, the crane being configured in a non-operative configuration; translating vertically the crane frame along the structural tower towards the upper end of the structural tower; and configuring the crane in an operative configuration.

In an embodiment, configuring the crane in the operative configuration comprises pivoting upwardly at least one of a boom and a gantry of the crane.

In an embodiment, engaging the crane frame comprises engaging at least one bearing assembly of the crane frame with at least one longitudinally extending rail member mounted to the structural tower; and translating vertically the crane frame comprises slidingly displacing the crane frame along the at least one longitudinally extending rail member.

In an embodiment, translating vertically the crane frame comprises actuating at least one translation actuator mounted to the crane frame in consecutive reciprocating movements.

In an embodiment, the structural tower comprises a central section and a plurality of peripheral sections extending radially from the central section and the at least one longitudinally-extending rail member comprises at least two longitudinally-extending rail members. Engaging the translatable crane can further comprise engaging the crane frame with two longitudinally-extending rail members extending between two adjacent ones of the peripheral sections.

In an embodiment, the crane frame surrounds at least one of the peripheral sections of the structural tower.

According to a further general aspect, there is provided a method for erecting a structural tower, the method comprising: (a) providing a plurality of tower sections; (b) engaging a translatable crane assembly with a lower one of the tower sections; (c) engaging a second one of the tower sections with a cable operatively engaged with the translatable crane assembly; (d) hoisting the second one of the tower sections towards an upper end of the lower one of the tower sections; (e) securing the second one of the tower sections to the lower one of the tower sections; and (f) translating the translatable crane assembly vertically along the secured tower sections towards an upper end thereof.

In an embodiment, the method further comprises: engaging another one of the tower sections with the cable; hoisting the other one of the tower sections towards the upper end of the secured tower sections; securing the other one of the tower sections to the upper end of the secured tower sections; and translating the translatable crane assembly vertically along the secured tower sections towards the upper end thereof.

In an embodiment, the method further comprises carrying sequentially the step of engaging another one of the tower sections with the cable to the step of translating the translatable crane assembly vertically along the secured tower sections towards the upper end thereof until a predetermined height of the structural tower has been reached.

In an embodiment, engaging the translatable crane assembly with the lower one of the tower sections further comprises engaging a crane frame with at least one longitudinally extending rail member extending along the lower one of the tower sections. Engaging the crane frame can also comprise engaging at least one bearing assembly of the crane frame with the at least one longitudinally extending rail member mounted to the structural tower; and translating vertically the translatable crane assembly comprises slidingly displacing the crane frame along the at least one longitudinally extending rail member.

In an embodiment, the translatable crane assembly comprises a crane configurable in a non-operative configuration and a plurality of operative configurations and wherein the cable is operatively engaged with the crane, the method further comprises configuring the crane in the non-operative configuration before engaging the translatable crane assembly with the lower one of the tower sections.

In an embodiment, the second one of the tower sections further comprises at least one longitudinally extending rail member, and securing the second one of the tower sections to the lower one of the tower sections further comprises aligning the at least one longitudinally extending rail member of the lower one of the tower sections with the at least one longitudinally extending rail member of the second one of the tower sections. Each one of the tower sections can further comprise at least one longitudinally extending rail member and securing the other one of the tower sections to the upper end of the secured tower sections can comprise aligning the at least one longitudinally extending rail member of the tower sections.

In an embodiment, the method further comprises a step of translating the translatable crane assembly towards an upper end of the lower one of the tower sections and configuring the crane in an operative configuration before engaging a second one of the tower sections with the cable. Configuring the crane in the operative configuration can comprise pivoting upwardly at least one of a boom and a gantry of the crane.

In an embodiment, the structural tower comprises a central section and a plurality of peripheral sections extending radially from the central section and the at least one longitudinally-extending rail member comprises at least two longitudinally-extending rail members, and wherein engaging the translatable crane assembly further comprises engaging the translatable crane assembly with two longitudinally-extending rail members extending between two adjacent ones of the peripheral sections. The translatable crane assembly can surround at least one of the peripheral sections of the structural tower when engaged therewith. In an embodiment, hoisting the second one of the tower sections further comprises actuating the crane assembly to wind up the cable.

In an embodiment, translating vertically comprises actuating at least one translation actuator mounted to the translatable crane assembly in consecutive reciprocating movements.

According to another general aspect, there is provided a method for hoisting a wind turbine component to an upper end of a structural tower, the method comprising: engaging a translatable crane assembly with the structural tower at a lower end thereof; translating the translatable crane assembly along the structural tower towards an upper end thereof; engaging the wind turbine component with a cable operatively engaged with the translatable crane assembly; and hoisting the wind turbine component with the translatable crane assembly.

In an embodiment, the wind turbine component comprises a nacelle and the nacelle is hoisted to the upper end of the structural tower, the method further comprises: securing the nacelle to the upper end of the structural tower.

In an embodiment, engaging the translatable crane assembly with the structural tower at the lower end thereof comprises engaging a crane frame with at least one longitudinally extending rail member extending along the structural tower.

In an embodiment, the translatable crane assembly comprises a crane configurable in a non-operative configuration and a plurality of operative configurations and the method further comprises configuring the crane in the non-operative configuration before engaging the translatable crane assembly with the structural tower.

In an embodiment, engaging the wind turbine component with the cable further comprises configuring the crane in a configuration by pivoting upwardly at least one of a boom and a gantry of the crane.

In an embodiment, translating translatable crane assembly comprises actuating at least one translation actuator mounted to the translatable crane assembly in consecutive reciprocating movements.

In an embodiment, engaging the translatable crane assembly comprises engaging at least one bearing assembly of the translatable crane assembly with the at least one longitudinally extending rail member mounted to the structural tower; and translating the translatable crane assembly comprises slidingly displacing the translatable crane assembly along the at least one longitudinally extending rail member.

In an embodiment, the structural tower comprises a central section and a plurality of peripheral sections extending radially from the central section and the at least one longitudinally-extending rail member comprises at least two longitudinally-extending rail members, and engaging the translatable crane assembly further comprises engaging the translatable crane assembly with two longitudinally-extending rail members extending between two adjacent ones of the peripheral sections. The crane frame can surround at least one of the peripheral sections of the structural tower when engaged therewith.

### BRIEF DESCRIPTION OF THE DRAWINGS

FIG. 1 is a rear perspective view of a wind turbine tower assembly having a translatable crane assembly mounted to a structural tower thereof in accordance with an embodiment;

FIG. 2 is a perspective view, enlarged, of a lower tower section of the structural tower, in accordance with an embodiment, with the translatable crane assembly shown in FIG. 1 mounted adjacent to a lower end thereof;

FIG. 3 is a perspective view, enlarged, of the lower tower section of the structural tower with the translatable crane assembly shown in FIG. 2 translated upwardly, the translatable crane assembly being configured in a non-operative configuration;

FIG. 4 is a perspective view, enlarged, of the translatable crane assembly shown in FIG. 2 and a first intermediate tower section of the structural tower, in accordance with an embodiment, the translatable crane assembly being mounted to an upper end of the lower tower section of the structural tower and configured in an operative configuration;

FIG. 5 is a perspective view, enlarged, of the translatable crane assembly hoisting the first intermediate tower section of the structural tower shown in FIG. 4;

FIG. 6 is a perspective view of the first intermediate tower section of the structural tower hoisted by the translatable crane assembly being disposed to the upper end of the lower tower section;

FIG. 7 is a perspective view of the first intermediate tower section of the structural tower shown in FIG. 4 mounted to the upper end of the lower tower section;

FIG. 8 is a perspective view of the structural tower of the wind turbine assembly wherein a plurality of tower sections are mounted in a consecutive end-to-end relationship with the translatable crane assembly being mounted to a next to last tower section and hoisting an upper tower section of the structural tower;

FIG. 9 is a perspective view of the structural tower shown in FIG. 8 wherein the upper tower section is disposed to the next to last tower section;

FIG. 10 is a perspective view of the structural tower shown in FIG. 9 with the translatable crane assembly being mounted to the upper section of the tower sections with a cable thereof connected to a nacelle of the wind turbine tower assembly, in accordance with an embodiment;

FIG. 11 is a perspective view of the structural tower shown in FIG. 9 with the translatable crane assembly hoisting the nacelle to an upper end of the structural tower;

FIG. 12 is a perspective view, enlarged, of the upper section of the structural tower wherein the nacelle is disposed to the upper end of the structural tower by the translatable crane assembly;

FIG. 13 is a perspective view of the structural tower shown in FIG. 9 with the translatable crane assembly hoisting rotor blades, in accordance with an embodiment, towards an upper end of the structural tower;

FIG. 14 is a perspective view, enlarged, of the upper tower section of the structural tower wherein the rotor blades are operatively secured to the nacelle by the translatable crane assembly;

FIG. 15 is a rear perspective view, enlarged, of the upper tower section of the structural tower wherein the translatable crane assembly mounted to the upper tower section of the structural tower is reconfigured in the non-operative configuration; and

FIG. 16 is a rear perspective view of the structural tower wherein the translatable crane assembly, configured in the non-operative configuration, has been translated downwardly to the lower tower section of the structural tower.

It will be noted that throughout the appended drawings, like features are identified by like reference numerals.

### DETAILED DESCRIPTION

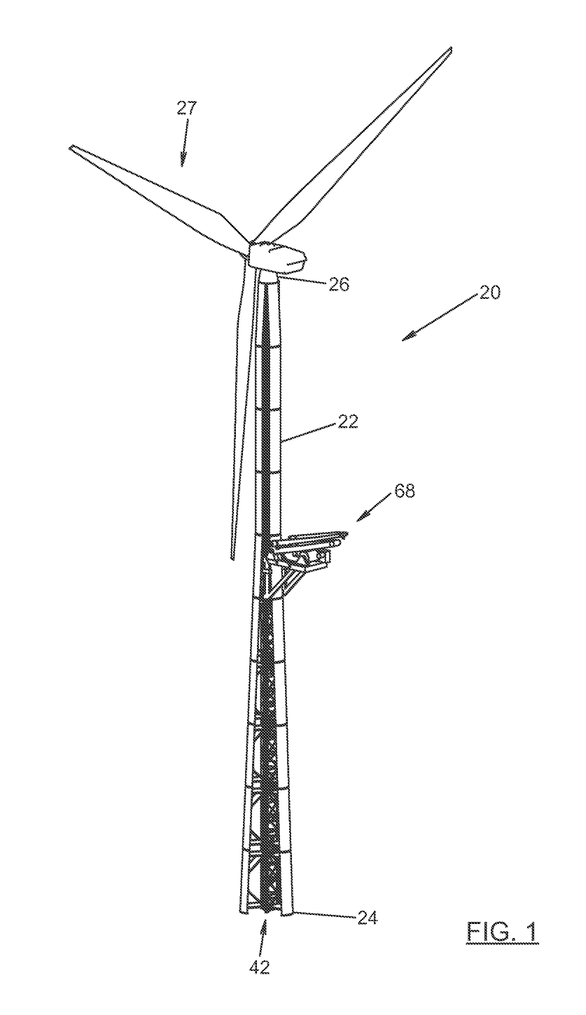

Referring now to the drawings and, more particularly, referring to FIG. 1, there is shown a wind turbine tower assembly 20 in accordance with an embodiment. The wind turbine tower assembly comprises a structural tower 22 having a lower end 24 securable to a foundation (not shown) and an upper end 26 configured to receive a wind turbine and blade assembly 27.

The structural tower 22 has a substantially clover shape with three leafs extending peripherally of a central section, as it will be described in more details below. The cross-sectional area of the structural tower 22 tapers from the lower end 24 towards the upper end 26, i.e. the cross-sectional area is wider near the lower end 24 than the upper end 26.

In an alternative embodiment (not shown), it is appreciated that the shape of the structural tower 22 including its cross-sectional shape can vary from the embodiment shown. For instance and without being limitative, it can have a tubular cross-section along its entire length or along a section thereof.

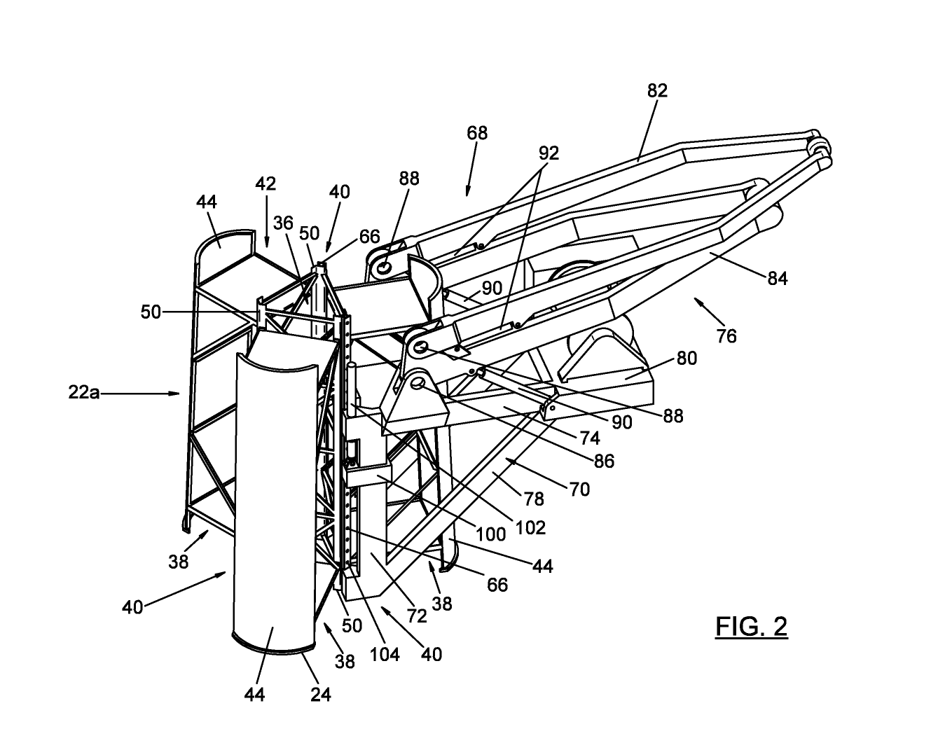

In a cross-sectional view, the structural tower 22 has an elongated tower frame which can be divided into one central section 36 and three peripheral sections 38 extending radially and peripherally from the central section 36. As shown in FIG. 2, structural concavities 40 are defined between adjacent peripheral sections 38 since the peripheral sections 38 are solely connected to one another at the periphery of the central section 36 and the structural tower 22 is free of structural members extending directly inbetween without being oriented inwardly towards the central section 36, as will be described in more details below.

Each one of the peripheral sections 38 further comprises an inner framework 42. Even if FIG. 2 shows a lower tower section 22a of the structural tower 22, the inner framework 42 extends along the tower height, from the lower end 24 to the upper end 26. In an embodiment, the inner framework 42 is a lattice framework (or open framework), extending substantially along the entire length of the peripheral sections 38. Each of the peripheral sections 38 includes a convex-shaped wall 44, which delimitates outwardly the peripheral sections 38. Each of the convex-shaped walls 44 ends with longitudinal side edges, spaced apart from one another. In the embodiment shown, the convex-shaped walls 44 are shaped like the arc of a circle; however, the shape of the convex-shaped walls 44 can vary from the embodiment shown. In the embodiment shown, the peripheral sections 38 are connected to one another through the inner framework 42. More particularly, structural members of the inner framework 42 extend inwardly from the longitudinal side edges of the convex-shaped walls 44 and are connected to the structural members of an adjacent one of the peripheral sections 38 at a longitudinal junction 50 of the peripheral sections 38. The inwardly-extending and connecting structural members define an inner V-shaped angle and the structural concavity 40.

The peripheral sections 38 can further include two side walls (not shown) extending towards the central section 36 from one of the longitudinal side edges of the convex-shaped walls 44. As the convex-shaped walls 44, the side walls can comprise two longitudinal side edges, spaced apart from one another. A first one of the longitudinal side edges, the peripheral longitudinal side edge, is juxtaposed to one of the longitudinal side edges of the convex-shaped wall 44 and a second one of the longitudinal side edges, the inner longitudinal side edge, is juxtaposed to an inner longitudinal side edge of a side wall of an adjacent one of the peripheral sections 38. In other words, the inner longitudinal side edges of the side walls are connected to another inner longitudinal side edge of another side wall, adjacent thereto. The connecting inner edges of the two side walls are located inwardly of the convex-shaped walls 44. The two connecting side walls define the inner V-shaped angle and the structural concavity 40.

In the embodiment shown, the convex-shaped walls 44 are configured in a tapered configuration from the lower end 24 to the upper end 26 of the structural tower 22. In the embodiment shown in FIG. 1, the upper ends of the convex-shaped walls 44 are configured in an adjacent configuration to define the central section 36 of the structural tower 22. At the upper end 26 of the structural tower 22, the longitudinal side edges of the convex-shaped walls 44 abut one another to define the circular cross-section. In the embodiment shown, the inwardly-extending structural members extend substantially horizontally and their width decreases from the lower end 24 to the upper end 26 of the structural tower 22.

Convex-shaped walls 44 and side walls, if any, can include a plurality of wall panels, as shown in FIG. 1, configured in an adjacent relationship to define the convex-shaped walls 44 and side walls, if any, extending between the lower end 24 and the upper end 26 of structural tower 22. In an alternative embodiment, the panels defining the convex-shaped walls 44 and side walls, if any, can extend continuously between lower end 24 and upper end 26 of structural tower 22. In the embodiment shown, the structural tower 22 is divided in a plurality of tower sections 22a, 22b, 22c, 22d, 22e, 22f, 22g, 22h, 22i mounted in a consecutive end-to-end relationship, as will be described in more details below.

In the embodiment shown, the structural members extending inwardly from their respective convex-shaped wall 44 extend substantially parallel to one another. However, in alternative embodiments (not shown), they can diverge from one another. In a non-limitative embodiment, they can diverge from one another and define an angle up to about 20° with a configuration wherein they extend substantially parallel to one another, i.e. an angle of up to about 40° is defined between both inwardly-extending structural members. In still an alternative embodiment, the inwardly-extending structural members can converge towards one another from the periphery towards the central section 36.

In the embodiment shown, the central section 36 has a substantially circular cross-section. However, one skilled in the art will appreciate that the shape of the central section 36 can vary from the embodiment shown.

Referring now to FIG. 2, there is shown an embodiment of the inner framework 42 which extends in the peripheral sections 38 of the structural tower 22, inwardly of the convex-shaped walls 44. The components of the inner framework 42 of each peripheral sections 38 are connected directly or indirectly with the respective one of the convex-shaped wall 44. Furthermore, components of the inner framework 42 of each of the peripheral sections 38 are also connected to components of the inner framework 42 of another adjacent peripheral section 38.

In an embodiment shown, the structural tower 22 can be free of side walls and the peripheral sections 38 can be connected to one another solely by the inner framework 42. In an alternative embodiment, the structural tower 22 can include side walls covering the inwardly-extending structural members. In an embodiment, the side walls are not structural components of the structural tower 22 but cover the inner framework 42 for aesthetic purposes.

The number of peripheral sections 38 can vary from the embodiment shown. For instance, the structural tower 22 can include two or more peripheral sections 38 extending peripherally from a central section 36. In an embodiment, the structural tower 22 can include three or more peripheral sections 38 extending peripherally from the central section 36. The shape of the central section 36 and the peripheral sections 38 can vary from the embodiment shown.

The structural tower 22 further includes longitudinally-extending rail members 66. The longitudinally-extending rail members 66 extend longitudinally between two adjacent peripheral sections 38 of the structural tower 22, inwardly of the convex-shaped walls 44. The rail members 66 are designed to support a translatable crane assembly 68 for hoisting the wind turbine and blade assembly 27 or other components to the upper end 26 of the structural tower 22. The translatable crane assembly 68 can also be used to erect the structural tower 22 by hoisting and supporting upper tower sections thereof, as will be described in more details below.

The longitudinally-extending rail members 66 are located in two of the structural concavities 40 of the structural tower 22, between two adjacent peripheral sections 38. The longitudinally-extending rail members 66 are mounted along the longitudinal junction 50 of the adjacent peripheral sections 38. In the embodiment shown, the structural tower 22 comprises two longitudinally-extending rail members 66. It is appreciated that the structural tower 22 can include more than two longitudinally-extending rail members 66. In the embodiment shown, the longitudinally-extending rail members 66 extend from the lower end 24 to the upper end 26 of the structural tower 22. In an alternative implementation, the longitudinally-extending rail members 66 can extend only along a section of the structural tower 22. In an embodiment, the longitudinally-extending rail members 66 extend substantially parallel to one another.

Referring to FIG. 2, there is shown that a lifting assembly is slidably mounted to two consecutive longitudinally-extending rail members 66. In the embodiment shown, the lifting assembly comprises a translatable crane assembly 68 having a crane frame 70 that surrounds outwardly one of the peripheral sections 38 and that is slidably mounted to the longitudinally-extending rail members 66. In the embodiment shown, the crane frame 70 has a substantially triangular prism shape; however, the shape of the crane frame 70 can vary from this embodiment. Two vertically-extending frame members 72 are slidingly engaged with a respective one of the longitudinally-extending rail members 66 through a bearing assembly (not shown).

The crane frame 70 further comprises two horizontally-extending frame members 74 supporting a pivotable crane 76 and having a proximal end connected to a respective one of the vertically-extending frame members 72, two diagonally-extending frame members 78 connecting together distal ends of the vertically-extending frame members 72 and the horizontally-extending frame members 74, and transversal frame members 80 connecting the horizontally-extending frame members 74 together and supporting a winch assembly of the translatable crane assembly 68, as will be described in more details below.

The translatable crane assembly 68 and, more particularly, the crane frame 70 further comprises translation actuators for translating the crane frame 70 along rail members 66 of the structural tower 22. Translation actuators (or mechanisms), such as and without being limitative a high-lift jack or cable assembly, can be used. In an embodiment, the translatable crane assembly 68 also includes at least one brake assembly (not shown) mounted to the crane frame 70. The brake assembly is configurable in an engaged configuration to secure the crane frame 70 at a position along the structural tower 22 and a disengaged configuration to allow translation of the crane frame 70 along the structural tower 22. Thus, when the translation actuator is actuated to translate the translatable crane assembly 68 along the structural tower 22, the brake assembly is configured in the disengaged configuration. Otherwise, the brake assembly is configured in the engaged configuration to prevent displacement of the translatable crane assembly 68 along the structural tower 22.

In the embodiment shown, for translating the translatable crane assembly 68 and, more particularly, the crane frame 70 along the structural tower 22, or a section thereof, each one of the vertically-extending frame members 72 comprises a sliding block 100 slidably engaged therewith. The sliding block 100 can translate along the vertically-extending frame members 72 between a lower configuration and an upper configuration. In the lower configuration, the sliding block 100 is slightly above a lower end of the vertically-extending frame members 72 while in the upper configuration, the sliding block 100 is slightly below an upper end of the vertically-extending frame members 72.

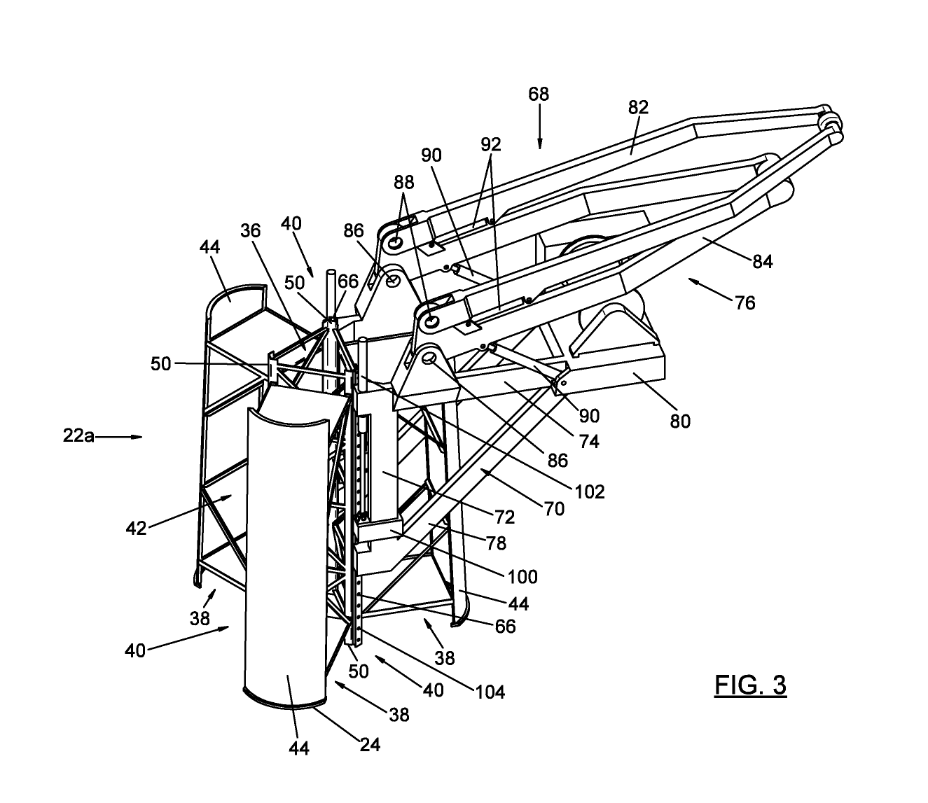

As mentioned above, the lower end and the upper end of the vertically-extending frame members 72 are slidably engaged with the longitudinally-extending rail members 66. Each one of the translation actuators 102 has a first end pivotally mounted to a respective one of the sliding block 100 and extends through an aperture defined through a respective one of the vertically-extending frame members 72, close to the upper end. In the embodiment shown, the translation actuator 102 comprises a hydraulic cylinder configurable between a compacted configuration (FIG. 2) and an expanded configuration (FIG. 3). A barrel of the hydraulic cylinder is secured to the upper end of the vertically-extending frame members 72 while a piston translates within the barrel between the compacted configuration and the expanded configuration. In the embodiment shown, a free end of the piston is secured to the sliding block 100. The translation actuators 102 are actuated to translate upwardly the translatable crane assembly 68 along the structural tower 22, or a section thereof.

Each one of the longitudinally-extending rail members 66 comprises a slotted track with a plurality of apertures 104 defined therein. The vertically-extending frame members 72 comprise pawls engageable with the apertures 104 defined in the rail members 66. In an embodiment, at least one pawl is provided close to the upper end of the vertically-extending frame members 72 and at least one pawl is provided close to the lower end of the vertically-extending frame members 72. Each one of the sliding blocks 100 is also provided with at least one pawl engageable in the apertures 104 of the rail members 66. Thus, the translatable crane assembly 68 is provided with at least two sets of pawls. A first one of the sets is mounted to the sliding blocks 100 and a second one of the sets is mounted to the crane supporting section of the crane frame 70 and, in the embodiment shown, the vertically-extending frame members 72. The pawl and apertures 104 are engageable together to allow translation in only one direction, towards the upper end of the structural tower 22, or a section thereof, and prevent translation in the opposite direction, towards the lower end.

To hoist the translatable crane assembly 68, the translation actuators 102 are configured from the compacted configuration into the expanded configuration. Since the barrels of the translation actuators 102 are secured to the vertically-extending frame members 72, the pistons of the translation actuators 102 are secured to the sliding blocks 100, and the pawls of the sliding blocks 100 are engaged with the apertures 104 of the rail members 66, which prevent translation towards the lower end of the structural tower 22, the vertically-extending frame members 72 are translated upwardly while the sliding blocks 100 remain at the same height along the structural tower 22. Then, the translation actuators 102 are reconfigured in the compacted configuration. The pawls of the vertically-extending frame members 72 are then engaged with the lower adjacent apertures to prevent downward translation of the translatable crane assembly 68. By reconfiguring the translation actuators 102 in the compacted configuration, the sliding blocks 100 are translated upwardly towards the upper end of the vertically-extending frame members 72. During this step, the translatable crane assembly 68 remains at the same height along the structural tower 22, or the section thereof. When the translation actuators 102 are reconfigured from the compacted configuration into the expanded configuration, the pawls of the sliding blocks 100 are then engaged with the lower adjacent apertures to prevent downward translation of the translatable crane assembly 68. These steps are repeated until the translatable crane assembly 68 reaches a predetermined position along the structural tower 22, or a section thereof.

To translate the translatable crane assembly 68 downwardly along the structural tower 22, each one of the pawls is associated with a suitable mechanism to override the engagement of the pawl with the apertures 104 of the rail members 66. For instance, the pawls of the vertically-extending frame members 72 are first configured in a non-operative configuration (i.e. a configuration allowing translation in both directions) while maintaining the pawls of the sliding blocks 100 in an operative configuration (i.e. a configuration allowing translation in only one direction and preventing translation in the opposed direction). By configuring the pawls of the vertically-extending frame members 72 in the non-operative configuration, the translatable crane assembly 68 translates downwardly along the structural tower 22, or a section thereof. During this step, the sliding blocks 100 remain at the same height along the structural tower 22, or the section thereof, since their pawls are configured in the operative configuration and engaged with the apertures 104 of the rail member 66. Then, the pawls of the vertically-extending frame members 72 are reconfigured in the operative configuration and the pawls of the sliding blocks 100 are configured in the non-operative configuration. The pawls of the vertically-extending frame members 72 are then engaged with the lower adjacent apertures to prevent downward translation of the translatable crane assembly 68. The sliding blocks 100 translate downwardly until they reach the lower configuration with respect to the vertically-extending frame members 72 and are then reconfigured in the operative configuration. During downward translation of the sliding blocks 100, the translatable crane assembly 68 remains at the same height along the structural tower 22, or the section thereof.

Thus, when translating the translatable crane assembly 68 upwardly, at least one of the sets of pawls, either the first set or the second set, is configured in the operative configuration and engaged with one of the apertures defined in the rail member 66. The other set of pawls, which is translated upwardly relative to the rail member 66, is consecutively disengaged from one of the apertures and engaged with another one of the apertures located above. Once the sliding block 100 has reached, for instance, either the lower or the upper configuration, the set of pawls which was translated upwardly is configured in the operative configuration and engaged with one of the apertures defined in the rail member 66 and the other set of pawls is then consecutively disengaged from one of the apertures and engaged with another one of the apertures located above. The sequence is repeated until the translatable crane assembly 68 reaches a predetermined position along the structural tower 22. When translating the translatable crane assembly 68 upwardly, the sets of pawls are configured in the operative configuration and at least one of them is engaged with one of the apertures defined in the rail member 66 and at least one of the sets of pawls is consecutively disengaged from one of the apertures and engaged with another one of the apertures located above.

When translating the translatable crane assembly 68 downwardly, at least one of the sets of pawls, either the first set or the second set, is configured in the operative configuration and engaged with one of the apertures defined in the rail member 66. The other set of pawls is configured in the non-operative configuration to allow translation in both directions and is moved downwardly relative to the rail member 66. Once the sliding block 100 has reached, for instance, either the lower or the upper configuration, the set of pawls, which was moved downwardly, is configured in the operative configuration and engaged with one of the apertures defined in the rail member 66 and the other set of pawls is configured in the non-operative configuration and moved downwardly relative to the rail member 66. The sequence is repeated until the translatable crane assembly 68 reaches a predetermined position along the structural tower 22. When translating the translatable crane assembly 68 downwardly, at least one of the sets of pawls is configured in the operative configuration and engaged with one of the apertures defined in the rail member 66 and at least one of the sets of pawls is configured in the non-operative configuration and moved downwardly.

In an alternative embodiment, it is appreciated that other reciprocating actuators can be used as translation actuators 102 than the hydraulic cylinders described above. Furthermore, the brake assembly can differ from the pawl and ratchet assembly described above.

The translatable crane assembly 68 further comprises the pivotable crane 76, which is pivotally mounted to the crane frame 70 and, more particularly, the two horizontally-extending frame members 74. The pivotable crane 76 comprises a pivotable boom 82 and a gantry 84 (or counter-boom). In the embodiment shown, the pivotable boom 82 and the gantry 84 are substantially V-shaped with the gantry 84 being shorter in length than the pivotable boom 82. As shown in FIGS. 2 to 4, the gantry 84 is pivotally mounted to the horizontally-extending frame members 74 through a gantry pivoting assembly 86 and pivots about a gantry pivot axis. The pivotable boom 82 is pivotally mounted to the arms of the gantry 84, close to the gantry pivoting assembly 86, through a boom pivoting assembly 88 and pivots about a boom pivot axis, which is substantially parallel to and vertically spaced-apart from the gantry pivot axis. Thus, the pivotable boom 82 and the gantry 84 pivot independently abut their own pivot axes, as will be shown in more details below.

The pivotable crane 76 and, more particularly, the pivotable boom 82 and the gantry 84 are operatively connected to one another and/or to the crane frame 70 through actuators 90, 92, such as and without being limitative, hydraulic cylinders for configuring the pivotable boom 82 and the gantry 84 between a non-operative configuration and a plurality of operative configurations. In the embodiment shown, the gantry actuators comprise two hydraulic cylinders 90 having a first end pivotally mounted to a rear section of the horizontally-extending frame members 74 and a second end pivotally mounted to the gantry 84. The pivotable boom actuators comprise two hydraulic cylinders 92 having a first end pivotally mounted to the gantry 84 and a second end pivotally mounted to the pivotable boom 82.

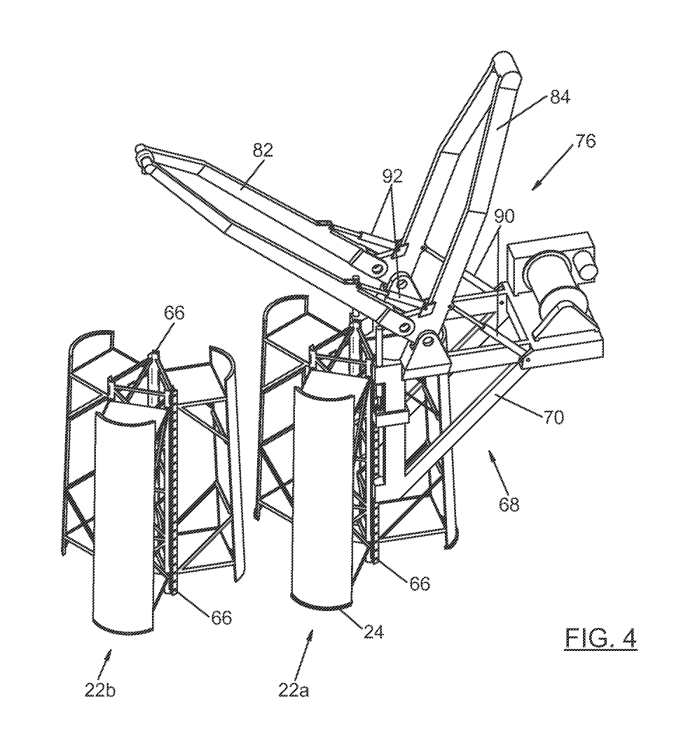

In the non-operative configuration shown in FIGS. 1 to 3, the pivotable boom 82 and the gantry 84 are superposed and extend substantially parallel to the horizontally-extending frame members 74 of the crane frame 70, rearwardly of the structural tower 22. In the embodiment shown, a relatively small acute angle is defined between the horizontally-extending frame members 74 and each one of the pivotable boom 82 and the gantry 84. In the operative configurations shown in FIGS. 4 to 14, non-zero angles are defined between the pivotable boom 82 and the horizontally-extending frame members 74 of the crane frame 70, between the pivotable boom 82 and the gantry 84, and between the gantry 84 and the horizontally-extending frame members 74 of the crane frame 70. It is appreciated that the pivotable boom 82 and the gantry 84 can be configured in a plurality of configurations.

Turning now to FIGS. 2 to 16, a method for erecting a structural tower for a wind turbine tower assembly will be described. First, a lower tower section 22a of the structural tower 22 is provided. The lower end 24 of the lower tower section 22a can be secured to a foundation (not shown), as it is known in the art. The lower tower section 22a comprises two longitudinally-extending rail members 66. The translatable crane assembly 68 is operatively mounted to the lower tower section 22a and, more particularly, is engaged with the longitudinally-extending rail members 66. As shown in FIG. 2, the translatable crane assembly 68 is mounted adjacent to the lower end 24 of the lower tower section 22a with the pivotable crane 76 in a non-operative configuration. Then, with the translation mechanism, the translatable crane 68 is translated vertically towards an upper end of the lower tower section 22a. When translated vertically, the translatable crane assembly 68 slides along the longitudinally-extending rail members 66 to which it is operatively engaged. The displacement movement can be a continuously movement or a discrete movement including a plurality of consecutive steps. In an embodiment, the pivotable crane 76 is configured in the non-operative configuration when translated vertically. The translatable crane assembly 68 is translated vertically until it is positioned adjacent to an upper end of the lower tower section 22a, as shown in FIG. 3.

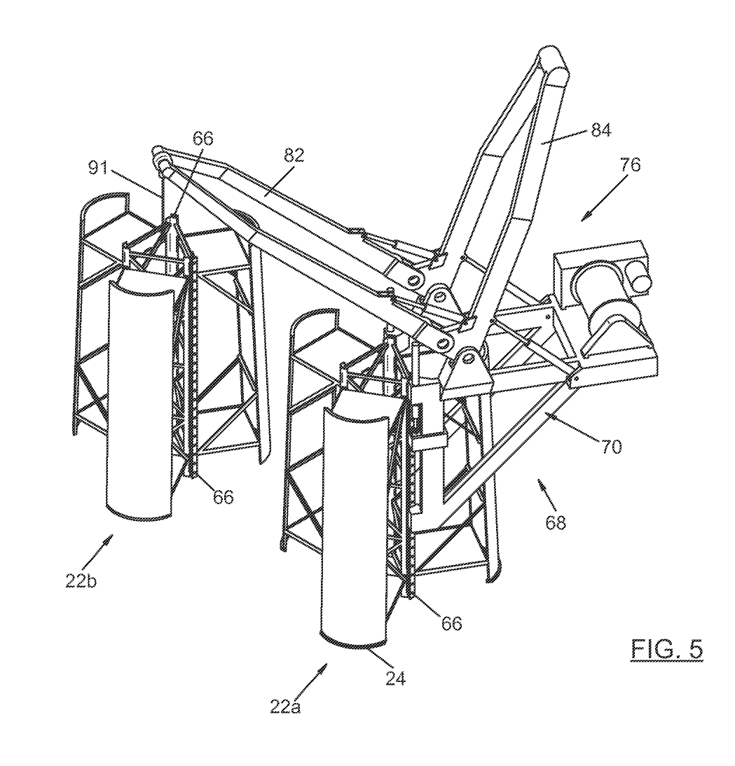

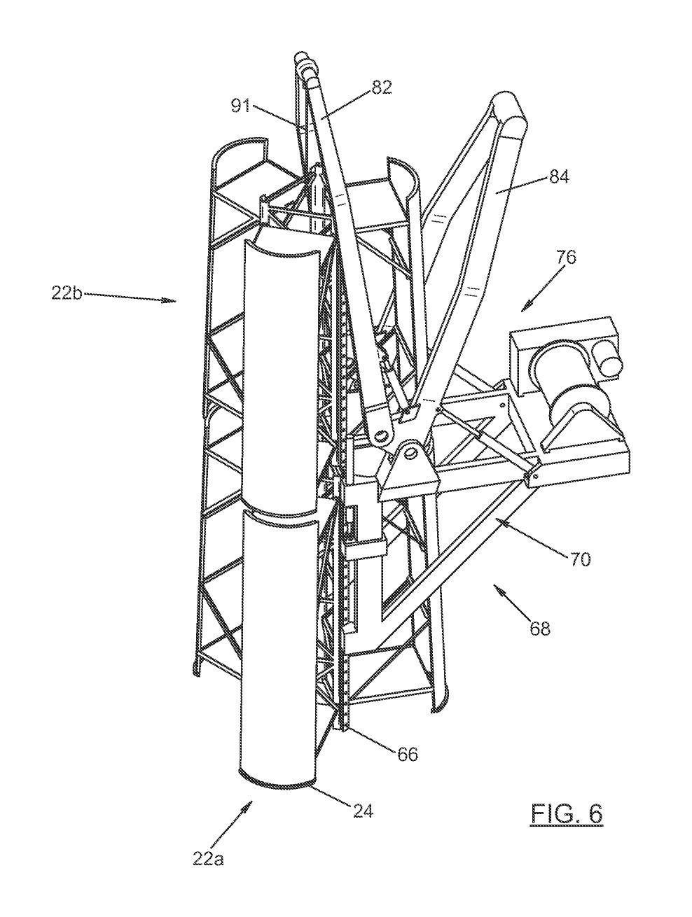

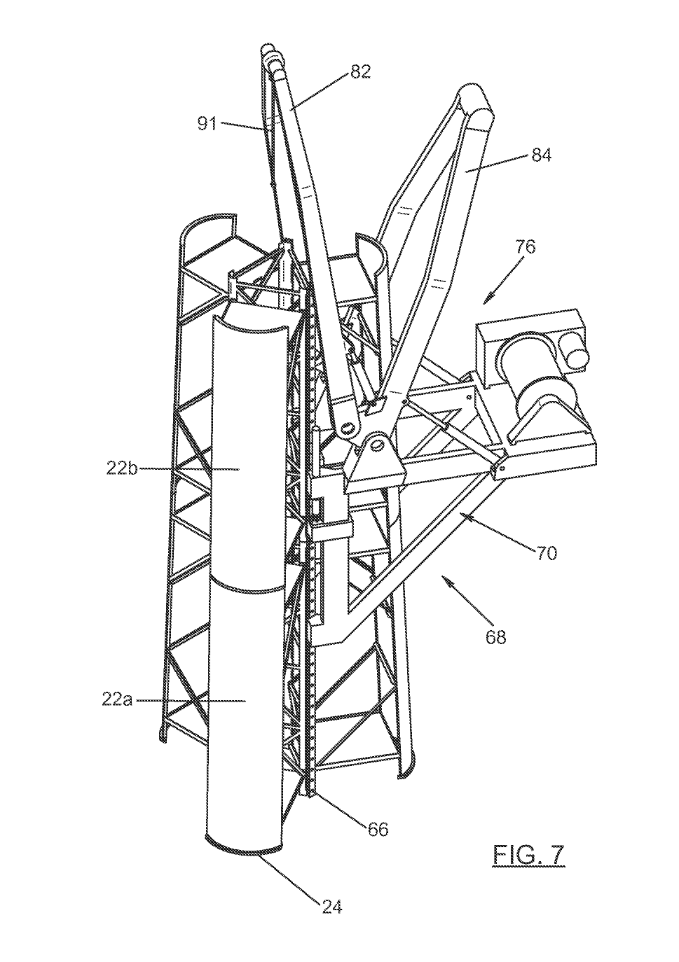

Then, the pivotable crane 76 of the translatable crane assembly 68, mounted close to the upper end of the lower tower section 22a, is configured in the operative configuration as shown in FIG. 4 and a first intermediate tower section 22b is attached to a cable 91 of the crane 76. To configure the pivotable crane 76 in the operative configuration, the pivotable boom 82 and gantry 84 are pivoted upwardly and forwardly. As mentioned above, the pivotable crane 76 can be configured in a plurality of the operative configurations, which can differ from the embodiment shown in FIG. 4. The first intermediate tower section 22b is hoisted by the crane 76 towards the upper end of the lower tower section 22a, as shown in FIG. 5. Then, the first intermediate tower section 22b is positioned above the lower tower section 22a, manipulated by the crane 76, with the central sections 36, the peripheral sections 38, and the longitudinally-extending rail members 66 respectively in register, as shown in FIGS. 6 and 7. Then, the first intermediate tower section 22b is secured to the lower tower section 22a and the cable 91 of the crane 76 is disconnected from the first intermediate tower section 22b. The first intermediate tower section 22b can be secured to the lower tower section 22a by any suitable method.

The translatable crane assembly 68 is then translated vertically towards an upper end of the first intermediate tower section 22b, with the pivotable crane 76 being configured either in the operative configuration or the non-operative configuration. Then, the same steps are performed to hoist another intermediate tower section and secure same to the already assembled (or secured) tower sections. A plurality of tower sections 22b, 22c, 22d, 22e, 22f, 22g, 22h, 22i are sequentially hoisted, positioned in a consecutive end-to-end relationship and secured to an adjacent lower one of the tower sections until a predetermined height of the structural tower 22 has been reached. The same steps are performed for hoisting, positioning, and securing the tower sections 22b, 22c, 22d, 22e, 22f, 22g, 22h, 22i. The translatable crane assembly 68 is translated vertically towards an upper end of lastly secured tower section.

In the embodiment shown, the structural tower 22 includes nine tower sections 22a, 22b, 22c, 22d, 22e, 22f, 22g, 22h, 22i; however, in alternative embodiments, the structural tower 22 could include more or less tower sections. Furthermore, the length of each tower section can differ from the embodiment shown and the tower sections of a structural tower 22 could be of non-equal length.

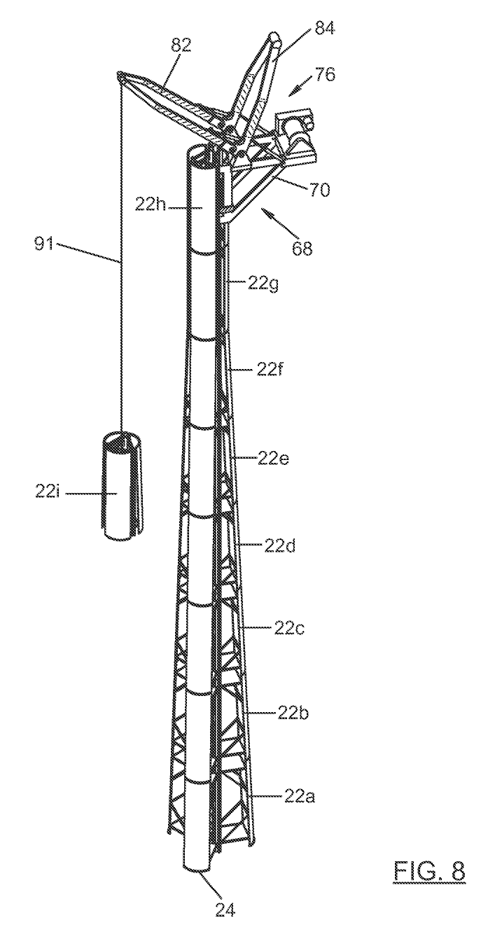

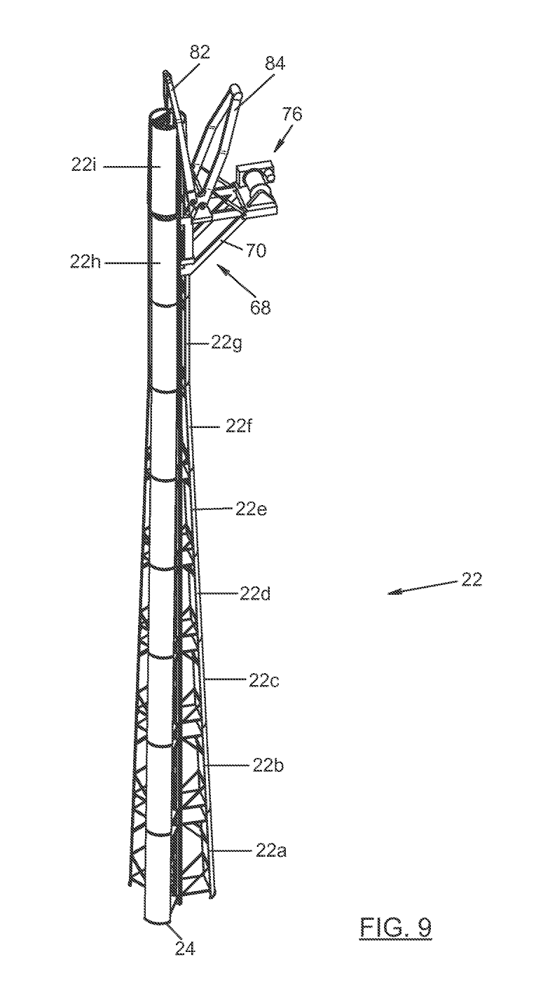

FIGS. 8 and 9 show an upper tower section 22i of the structural tower 22 being hoisted towards the upper end of the assembled tower sections 22a, 22b, 22c, 22d, 22e, 22f, 22g, 22h, positioned above the next to last (or penultimate) one 22h of the tower sections and secured thereto.

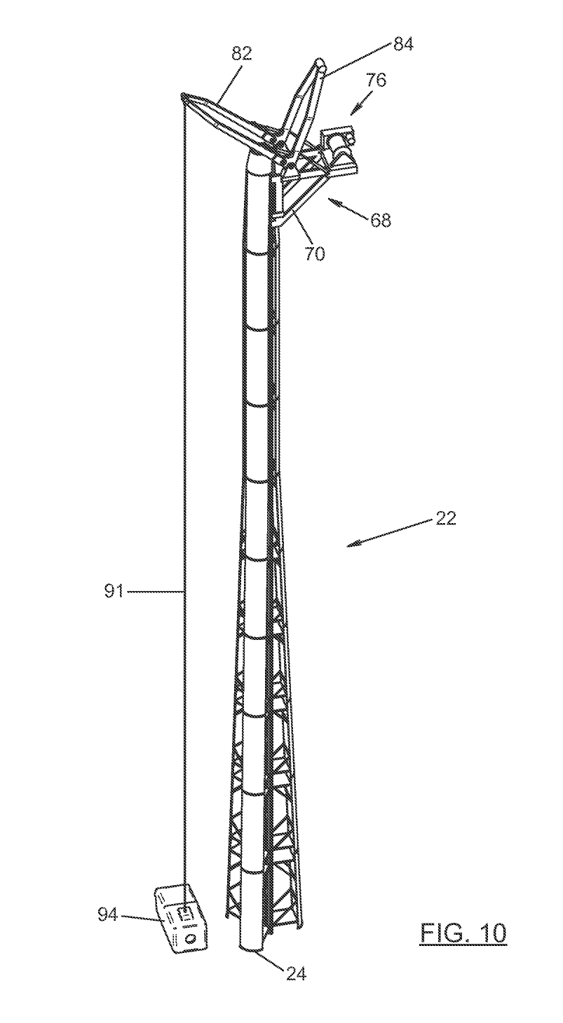

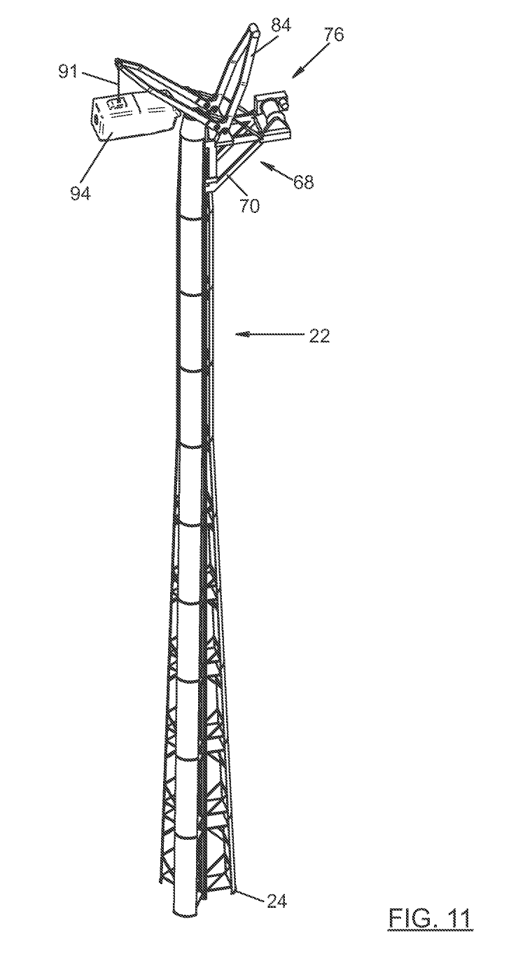

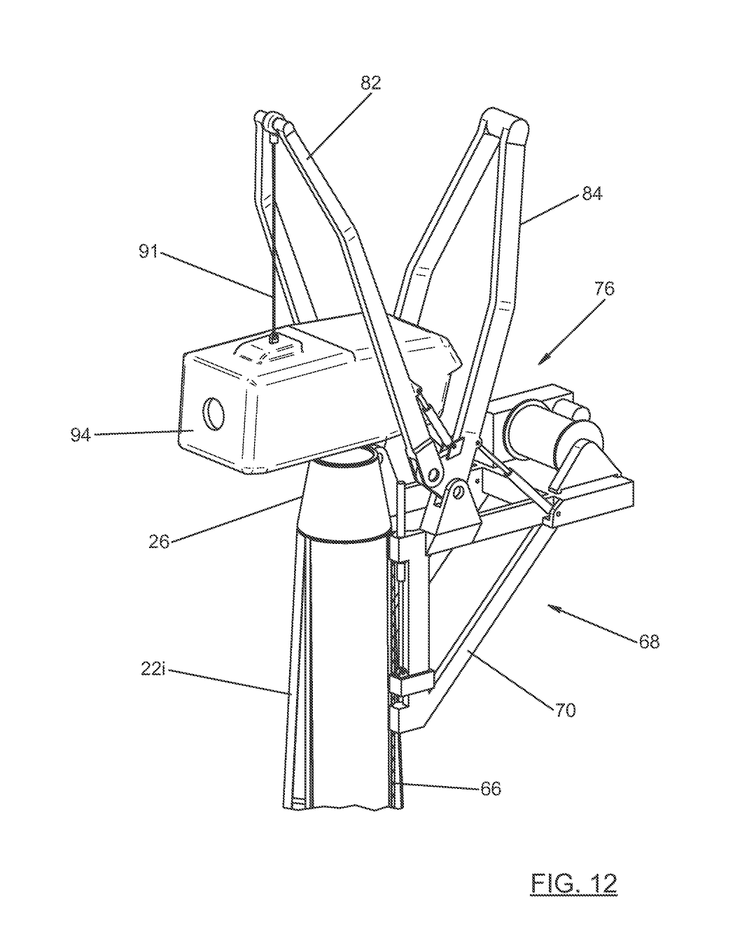

Once the structural tower 22 is fully erected, the crane 76 can be used to hoist and secure a nacelle 94 and rotor blades 96 of the wind turbine assembly to the upper end 26 of the structural tower 22. FIG. 10 shows that, for hoisting the nacelle 94, the translatable crane assembly 68 is positioned close to the upper end 26 of the structural tower 22 and, more particularly, close to an upper end of the upper tower section 22i. The cable 91 of the crane 76, configured in the operative configuration, is attached to the nacelle 94 of the wind turbine tower assembly. FIG. 11 shows the nacelle 94 being hoisted towards the upper end 26 of the structural tower 22 while FIG. 12 shows the nacelle 94 being disposed and secured to the upper end 26 of the structural tower 22. The nacelle 94 can be secured by known techniques to the upper end 26 of the structural tower 22.

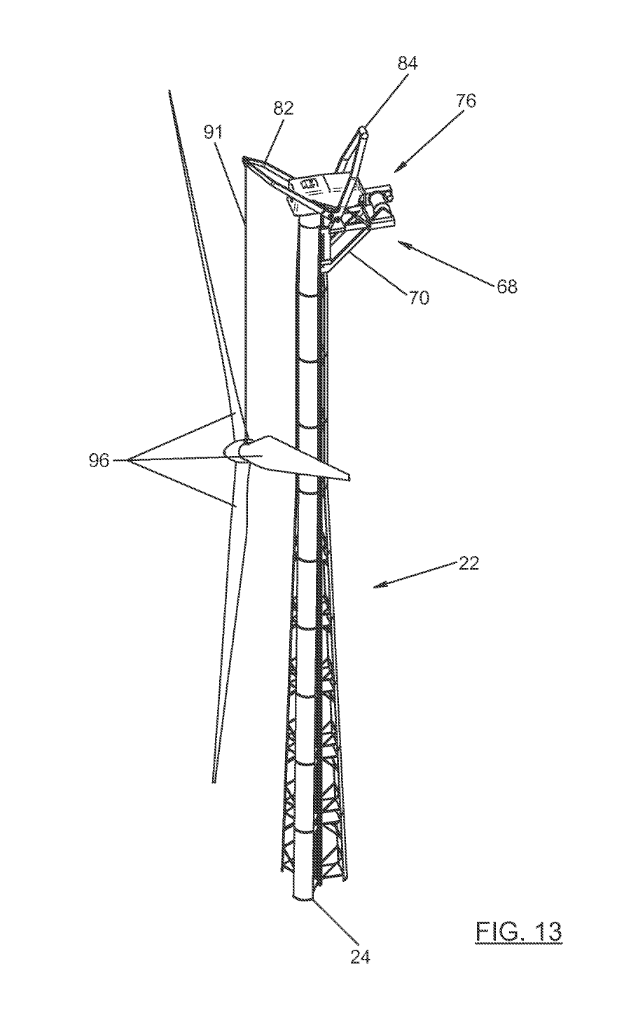

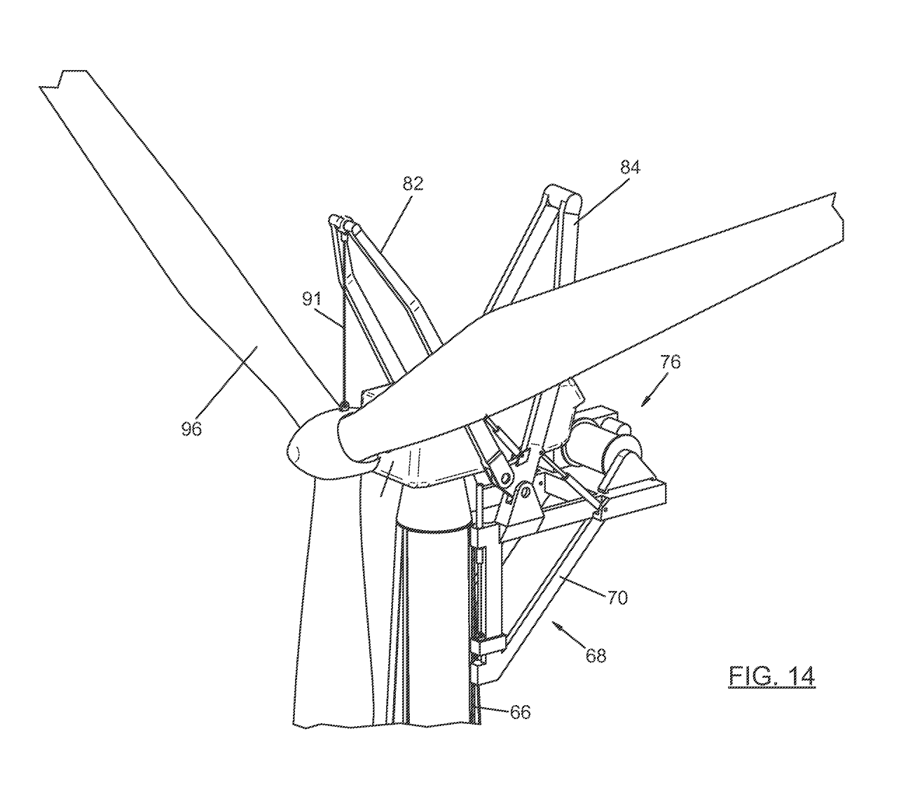

Once the nacelle 94 is mounted to the upper end 26 of the structural tower 22, the rotor blades 96 of the wind turbine assembly are hoisted towards the upper end 26 and secured to the nacelle 94. FIG. 13 shows an embodiment of rotor blades 96 being hoisted towards the upper end 26 of the structural tower 22 by the cable 91 attached thereto. FIG. 14 shows the rotor blades 96 being operatively secured to the nacelle 94 by the translatable crane assembly 68. The rotor blades 96 can be secured by known techniques to the nacelle 94.

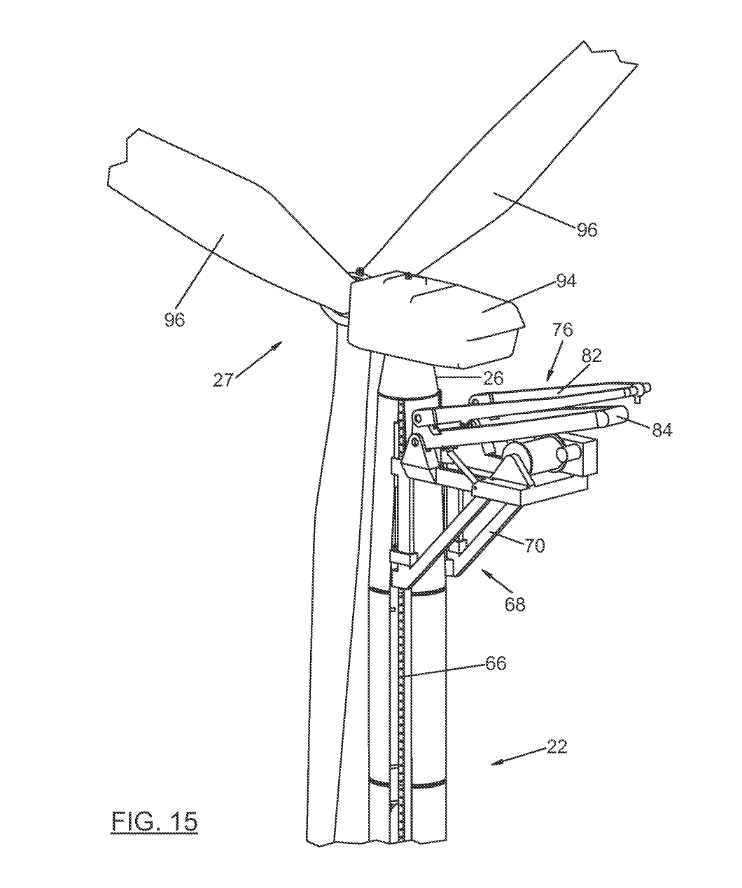

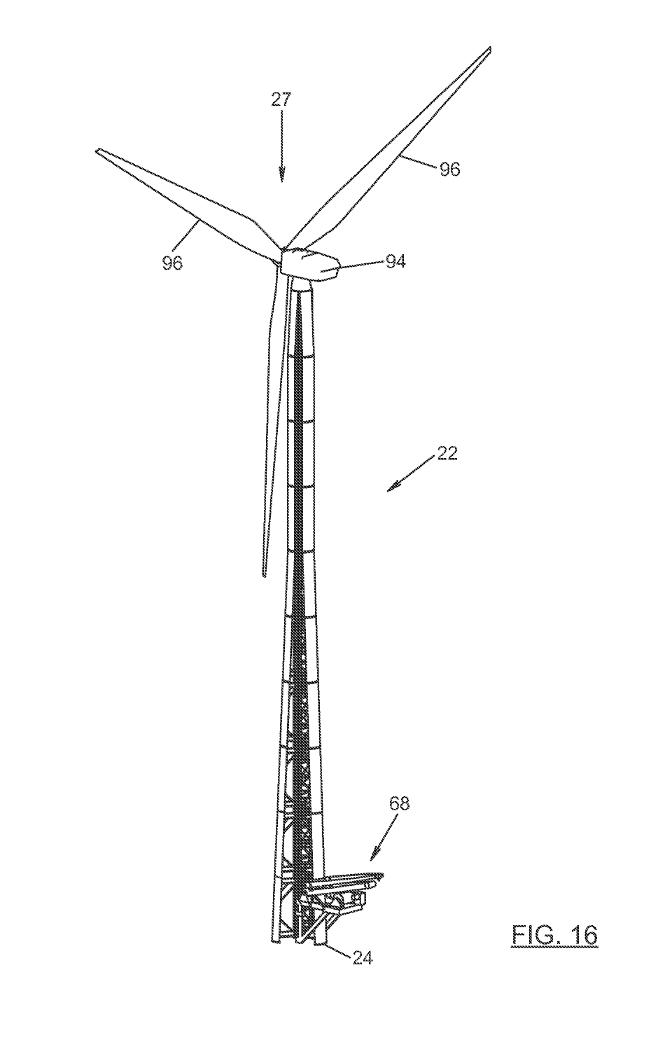

When the structural tower 22 is fully erected and all the desired wind turbine components, such as but without being limitative, the nacelle 94 and the rotor blades 96, have been hoisted to the upper end 26 of the structural tower 22, the crane 76 is reconfigured in the non-operative configuration, shown in FIG. 15, and the translatable crane assembly 68 is translated downwardly along the longitudinally-extending rail members 66, as shown in FIG. 16, until it reaches the lower end 24 of the structural tower 22, as shown in FIG. 16. Then, the translatable crane assembly 68 can be dismounted from the structural tower 22 or it can remain operatively mounted thereon. If other components must be hoisted towards the upper end 26 of the structural tower 22 or detached and lowered towards the ground, for replacement or maintenance purposes, for instance, the translatable crane assembly 68 can be used. If needed, the translatable crane assembly 68 can be translated substantially vertically towards the upper end 26 of the structural tower 22 or anywhere along its length and configured in the operative configuration.

In the embodiment shown, the translatable crane assembly 68 is operatively engaged with two longitudinally-extending rail members 66 but, in alternative embodiments (not shown) it can be operatively engaged with one or more longitudinally-extending rail members 66.

Moreover, although the embodiments of the wind turbine tower and translatable crane assembly and corresponding parts thereof consist of certain geometrical configurations as explained and illustrated herein, not all of these components and geometries are essential and thus should not be taken in their restrictive sense. It is to be understood, as also apparent to a person skilled in the art, that other suitable components and cooperations thereinbetween, as well as other suitable geometrical configurations, may be used for the wind turbine tower and translatable crane assembly, as will be briefly explained herein and as can be easily inferred herefrom by a person skilled in the art. Moreover, it will be appreciated that positional descriptions such as “above”, “below”, “left”, “right” and the like should, unless otherwise indicated, be taken in the context of the figures and should not be considered limiting.

Several alternative embodiments and examples have been described and illustrated herein. The embodiments of the invention described above are intended to be exemplary only. A person of ordinary skill in the art would appreciate the features of the individual embodiments, and the possible combinations and variations of the components. A person of ordinary skill in the art would further appreciate that any of the embodiments could be provided in any combination with the other embodiments disclosed herein. It is understood that the invention may be embodied in other specific forms without departing from the spirit or central characteristics thereof. The present examples and embodiments, therefore, are to be considered in all respects as illustrative and not restrictive, and the invention is not to be limited to the details given herein. Accordingly, while the specific embodiments have been illustrated and described, numerous modifications come to mind without significantly departing from the spirit of the invention. The scope of the invention is therefore intended to be limited solely by the scope of the appended claims.

1. A method for erecting a structural tower, the method comprising:
providing a plurality of tower sections;
engaging a translatable crane assembly with a lower one of the tower sections;
engaging a second one of the tower sections with a cable operatively engaged with the translatable crane assembly;
hoisting the second one of the tower sections towards an upper end of the lower one of the tower sections;
securing the second one of the tower sections to the lower one of the tower sections; and
translating the translatable crane assembly vertically along the secured tower sections towards the upper end thereof.

2. The method as claimed in claim 1, further comprising:
engaging another one of the tower sections with the cable;
hoisting the other one of the tower sections towards the upper end of the secured tower sections by actuating the crane assembly to wind up the cable;
securing the other one of the tower sections to the upper end of the secured tower sections;
translating the translatable crane assembly vertically along the secured tower sections towards the upper end thereof; and
carrying sequentially the step of engaging another one of the tower sections with the cable to the step of translating the translatable crane assembly vertically along the secured tower sections towards the upper end thereof until a predetermined height of the structural tower has been reached.

3. (canceled)

4. The method as claimed in claim 1, wherein engaging the translatable crane assembly with the lower one of the tower sections further comprises engaging a crane frame with at least one longitudinally extending rail member extending along the lower one of the tower sections by engaging at least one bearing assembly of the crane frame with the at least one longitudinally extending rail member mounted to the structural tower; and translating vertically the translatable crane assembly comprises slidingly displacing the crane frame along the at least one longitudinally extending rail member; and
wherein each one of the tower section, including the second one of the tower sections, further comprises at least one longitudinally extending rail member, and securing the other one of the tower sections to the upper end of the lower tower sections further comprises aligning the at least one longitudinally extending rail member of the lower tower sections with the at least one longitudinally extending rail member of the other one of the tower sections.

5. (canceled)

6. The method as claimed in claim 1, wherein the translatable crane assembly comprises a crane configurable in a non-operative configuration and a plurality of operative configurations and wherein the cable is operatively engaged with the crane, the method further comprising configuring the crane in the non-operative configuration before engaging the translatable crane assembly with the lower one of the tower sections and the method further comprises a step of translating the translatable crane assembly towards an upper end of the lower one of the tower sections and configuring the crane in one of the operative configurations before engaging another one of the tower sections with the cable by pivoting upwardly at least one of a boom and a gantry of the crane.

7-10. (canceled)

11. The method as claimed in claim 1, wherein the structural tower comprises a central section and a plurality of peripheral sections extending radially from the central section and the at least one longitudinally-extending rail member comprises at least two longitudinally-extending rail members, and wherein engaging the translatable crane assembly further comprises engaging the translatable crane assembly with two longitudinally-extending rail members extending between two adjacent ones of the peripheral sections with the translatable crane assembly surrounding at least one of the peripheral sections of the structural tower when engaged therewith.

12-13. (canceled)

14. The method as claimed in claim 1, wherein translating vertically comprises actuating at least one translation actuator mounted to the translatable crane assembly in consecutive reciprocating movements.

15. A method for hoisting a wind turbine component to an upper end of a structural tower, the method comprising:
engaging a translatable crane assembly with the structural tower at a lower end thereof;
translating the translatable crane assembly along the structural tower towards an upper end thereof;
engaging the wind turbine component with a cable operatively engaged with the translatable crane assembly; and
hoisting the wind turbine component with the translatable crane assembly.

16. The method as claimed in claim 15, wherein the wind turbine component comprises a nacelle and the nacelle is hoisted to the upper end of the structural tower, the method further comprising: securing the nacelle to the upper end of the structural tower.

17. The method as claimed in claim 15, wherein engaging the translatable crane assembly with the structural tower at the lower end thereof comprises engaging a crane frame with at least one longitudinally extending rail member extending along the structural tower and the translatable crane assembly comprises a crane configurable in a non-operative configuration and a plurality of operative configurations, the method further comprising configuring the crane in the non-operative configuration before engaging the translatable crane assembly with the structural tower and engaging the wind turbine component with the cable further comprises configuring the crane in a configuration by pivoting upwardly at least one of a boom and a gantry of the crane.

18-19. (canceled)

20. The method as claimed in claim 15, wherein translating translatable crane assembly comprises actuating at least one translation actuator mounted to the translatable crane assembly in consecutive reciprocating movements.

21. The method as claimed in claim 15, wherein engaging the translatable crane assembly comprises engaging at least one bearing assembly of the translatable crane assembly with the at least one longitudinally extending rail member mounted to the structural tower; and translating the translatable crane assembly comprises slidingly displacing the translatable crane assembly along the at least one longitudinally extending rail member.

22. The method as claimed in claim 17, wherein the structural tower comprises a central section and a plurality of peripheral sections extending radially from the central section and the at least one longitudinally-extending rail member comprises at least two longitudinally-extending rail members, and wherein engaging the translatable crane assembly further comprises engaging the translatable crane assembly with two longitudinally-extending rail members extending between two adjacent ones of the peripheral sections and the crane frame surrounds at least one of the peripheral sections of the structural tower when engaged therewith.

23. (canceled)

24. A wind turbine tower assembly comprising:
a structural tower having an elongated tower frame with at least one longitudinally-extending rail member; and
a translatable crane assembly having a crane frame slidably engageable with the at least one longitudinally-extending rail member and translatable along the elongated tower frame of the structural tower and a crane mounted to the crane frame.

25. The wind turbine tower assembly as claimed in claim 24, wherein the crane comprises a boom and a gantry pivotally mounted to the crane frame and selectively configurable in a non-operative configuration and a plurality of operative configurations.

26. (canceled)

27. The wind turbine tower assembly as claimed in claim 24, wherein the structural tower comprises a central section and a plurality of peripheral sections extending radially from the central section and the at least one longitudinally-extending rail member comprises at least two longitudinally-extending rail members, each one of the longitudinally-extending rail members extending between two adjacent ones of the peripheral sections and the crane frame surrounds at least one of the peripheral sections of the structural tower.

28-29. (canceled)

30. The wind turbine tower assembly as claimed in claim 24, wherein the translatable crane assembly further comprises at least one translation actuator mounted to the crane frame and actuable in consecutive reciprocating movements for translating the crane frame along the structural tower.

31. The wind turbine tower assembly as claimed in claim 30, wherein the at least one longitudinally-extending rail member comprises a slotted track with a plurality of apertures and the crane frame comprises at least one pawl engageable with the apertures to allow translation in a single direction.

32. The wind turbine tower assembly as claimed in claim 31, wherein the crane frame comprises at least one sliding block connected to the at least one translation actuator, the at least one of the pawls comprises at least two sets of pawls with a first one of the sets of pawls being mounted to the at least one sliding block and a second one of the sets of pawls being mounted to a crane supporting section of the crane frame.

33. The wind turbine tower assembly as claimed in 32, further comprising at least one brake assembly connected to the at least two sets of pawls and operative to configure the at least two sets of pawls in an operative configuration allowing translation in a single direction and a non-operative configuration allowing translation in both directions.

34. The wind turbine tower assembly as claimed in claim 24, wherein the structural tower comprises a plurality of tower sections superposed to one another and secured together, each one of the tower sections comprising a section of the at least one longitudinally-extending rail member, the sections of the at least one longitudinally-extending rail member being aligned to define the at least one longitudinally-extending rail member extending along the structural tower and the crane frame comprises bearing assemblies engageable with the at least one longitudinally-extending rail member.

35. (canceled)

36. The wind turbine tower assembly as claimed in claim 24, wherein the crane frame comprises a brake assembly configurable in an engaged configuration to secure the crane frame at a position along the structural tower and a disengaged configuration to allow translation of the crane frame along the structural tower.

37. A translatable crane assembly for a structural tower having at least one longitudinally-extending rail member, the translatable crane assembly comprising: a crane frame slidably engageable with the at least one longitudinally-extending rail member and a crane mounted to the crane frame.

38-39. (canceled)

40. The translatable crane assembly as claimed in claim 37, wherein the crane frame further comprises at least one translation actuator and actuable in consecutive reciprocating movements for translating the crane frame along the structural tower.

41. The translatable crane assembly as claimed in claim 40, wherein the at least one longitudinally-extending rail member comprises a slotted track with a plurality of apertures and the crane frame comprises at least one pawl engageable with the apertures to allow translation in a single direction.

42. The translatable crane assembly as claimed in claim 41, wherein the crane frame comprises at least one sliding block connected to the at least one translation actuator, the at least one of the pawls comprises at least two sets of pawls with a first one of the sets of pawls being mounted to the at least one sliding block and a second one of the sets of pawls being mounted to a crane supporting section of the crane frame.

43. The translatable crane assembly as claimed in 42, further comprising at least one brake assembly connected to the at least two sets of pawls and operative to configure the at least two sets of pawls in an operative configuration allowing translation in a single direction and a non-operative configuration allowing translation in both directions.

44-46. (canceled)

47. A method for mounting a translatable crane assembly having a crane frame and a crane mounted to the crane frame to an upper end of a structural tower, the method comprising:
engaging the crane frame with the structural tower, the crane being configured in a non-operative configuration;
translating vertically the crane frame along the structural tower towards the upper end of the structural tower; and
configuring the crane in an operative configuration.

48. The method as claimed in claim 47, wherein configuring the crane in the operative configuration comprises pivoting upwardly at least one of a boom and a gantry of the crane; engaging the crane frame comprises engaging at least one bearing assembly of the crane frame with at least one longitudinally extending rail member mounted to the structural tower; and translating vertically the crane frame comprises slidingly displacing the crane frame along the at least one longitudinally extending rail member; and translating vertically the crane frame comprises actuating at least one translation actuator mounted to the crane frame in consecutive reciprocating movements.

49-50. (canceled)

51. The method as claimed in claim 47, wherein the structural tower comprises a central section and a plurality of peripheral sections extending radially from the central section and the at least one longitudinally-extending rail member comprises at least two longitudinally-extending rail members, and wherein engaging the translatable crane further comprises engaging the crane frame with two longitudinally-extending rail members extending between two adjacent ones of the peripheral sections with the crane frame surrounding at least one of the peripheral sections of the structural tower.

52. (canceled)
